(19) United States
(12) Patent Application Publication
(10) Pub. No.: US 2008/0205201 A1
(43) Pub. Date: Aug. 28, 2008

(54) Time display apparatus

(76) Inventors: Hwa Su, Taipei City (TW); Alexander Chan Wang, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/149,056

(22) Filed: Apr. 25, 2008

Related U.S. Application Data
(63) Continuation-in-part of application No. 11/263,907, filed on Nov. 2, 2005.

(51) Int. Cl. G04B 19/32

(52) U.S. Cl. 368/226

(57) ABSTRACT

A time display apparatus is disclosed and comprises at least a housing, a timetable panel, three pointers and a backlight unit. The timetable panel is disposed in the housing. The three pointers are coated with variety of phosphorescence materials respectively and vertically arranged on the timetable panel in order. The backlight unit is disposed below the timetable panel to generate a light source with a fixed wavelength to illuminate the phosphorescence materials of the three pointers, thereby generating different colors for showing hour, minute and second respectively.

### REFERENCE TO RELATED APPLICATIONS

This Patent Application is being filed as a Continuation-in-Part of patent Application Ser. No. 11/263,907, filed 2 Nov. 2005, currently pending.

### FIELD OF THE INVENTION

The present invention generally relates to a time display apparatus, and more particularly to a plurality of pointers coated with variety of phosphorescence materials respectively to show hour, minute and second through the illumination of a backlight unit.

### BACKGROUND OF THE INVENTION

As time passed, the exhibition of displaying time becomes a great of diversities. People try to know the present time through various ways. At the beginning, there were primitive sundials, sandglasses, then mechanical clocks, and now digital clocks or watches. In FIG. 1, it is a perspective diagram showing the structure of the main body portion of a clock in the prior art. Herein, the main body portion of the clock comprises a clock housing 11, a timetable panel 12 and at least one pointer 13 wherein the clock housing 11 contains the timetable panel 12 and further contains the pointer 13 positioned above the timetable panel 12. Within the clock housing 11, the pointers 13 may comprises at least one hour pointer 14, one minute pointer 15 and one second pointer 16 wherein the length of the hour pointer 14 is shorter than that of the minute pointer 15 or that of the second pointer 16, and the width of the second pointer 16 is thinner than that of the hour pointer 14 or that of the minute pointer 15. There are many ways to display time with various combinations of the pointers 13.

In the early stage, the pointers can not be seen in the dark. However, with modifications made by people, the combinations of the pointers can be seen in the dark as the example represented in FIG. 2 which includes a perspective diagram and a dissection diagram showing the structure of the main body portion of a clock able to show time information in the dark in the prior art. The clock housing 11 in FIG. 1 holds a timetable panel 12 and a pointer 13 positioned above the timetable panel 12. In the cooperation with the time display apparatus structure in FIG. 1, adding fluorescent materials 21 into the pointer 13 to form a pointer 22 containing fluorescent materials 21. Furthermore, the pointer 22 contains an hour pointer 23, a minute pointer 24 and a second pointer 25 wherein the length of the hour pointer 23 is shorter than that of the minute pointer 24 or that of the second pointer 25, and the width of the second pointer 25 is thinner than that of the hour pointer 23 and that of the minute pointer 24. With the fluorescent pointers 22, the time information can be seen in the dark. However, the time period of light emitting is only temporary and limited by the characteristics of fluorescent materials. After a while, the light emitted from the pointers vanishes and becomes one of the disadvantages of the clocks utilizing the fluorescent materials. There is only one color shown by using the fluorescent material on the pointers.

To overcome the foregoing shortcoming, the inventor of the present invention based on years of experience in the related field to conduct extensive researches and experiments, and finally invented a time display apparatus as a method or a basis for resolving the foregoing drawback.

### SUMMARY OF THE INVENTION

Briefly, it is an objective of the present invention to provide a time display apparatus for displaying time with phosphorescent materials illuminated by light with a fixed wavelength. The present invention coats different phosphorescence materials on pointers made of transparent materials, and the pointers are illuminated by light with a fixed wavelength generated from a backlight unit to show different color, thereby representing time.

To achieve the foregoing objective, the time display apparatus comprises at least a housing, a timetable panel, three pointers and a backlight unit. The timetable panel is disposed in the housing. The three pointers are coated with variety of phosphorescence materials respectively and vertically arranged on the timetable panel in order. The backlight unit is disposed below the timetable panel to generate a light source with a fixed wavelength to illuminate the phosphorescence materials of the three pointers, thereby generating different colors for showing hour, minute and second respectively.

The housing can be a wrist watch or a clock. The three pointers can be composed of an hour pointer, a minute pointer and a second pointer. It should be noted that the hour pointer is usually shorter than the minute pointer and the second pointer to conveniently recognize the difference. The second pointer is therefore longer the minute pointer and the second pointer. The housing further comprises a transparent sheet that is attached to a periphery of the housing.

To make it easier for our examiner to understand the object of the invention, its innovative features and performance, a detailed description and technical characteristics of the present invention are described together with the drawings as follows.

### BRIEF DESCRIPTION OF THE DRAWINGS

FIG. 1 is a perspective diagram showing the structure of the main body portion of a clock in the prior art;

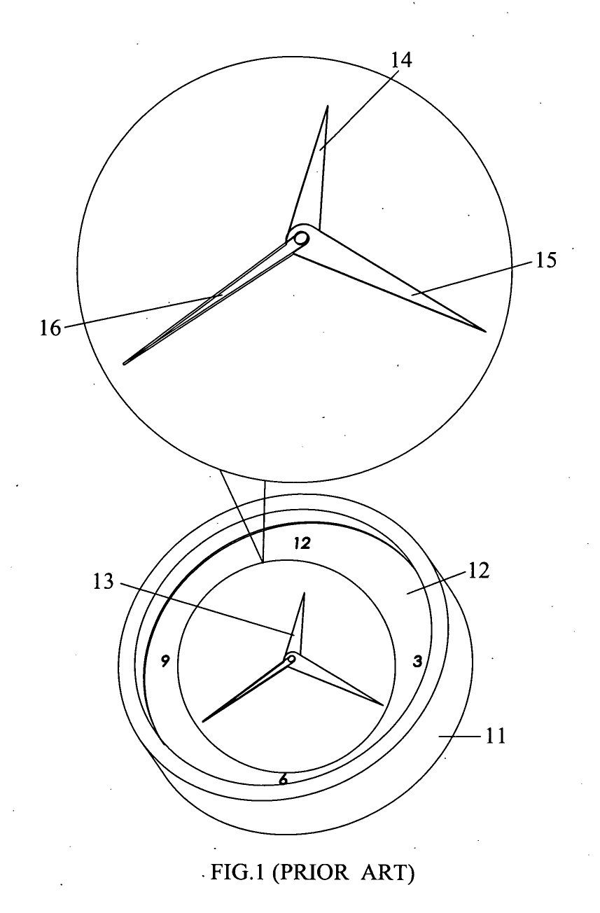

FIG. 2 includes a perspective diagram and a dissection diagram showing the structure of the main body portion of a clock able to show time information in the dark in the prior art;

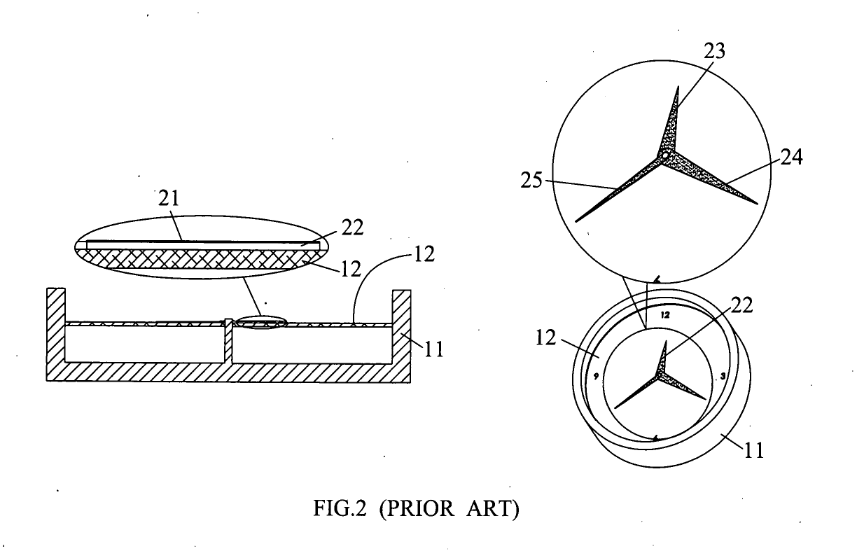

FIG. 3 is a schematic diagram illustrates a time display apparatus according to an embodiment of the present invention;

FIG. 4 is a cross-sectional diagram illustrates a time display apparatus according to an embodiment of the present invention;

FIG. 4 is a flowchart for creating various coloring by using different overlapping of pointers of the invention; and

FIG. 6 is a schematic diagram of another embodiment of the present invention with backlight units in various appearances and arrangements.

### DETAILED DESCRIPTION OF THE PREFERRED EMBODIMENTS

Referring to the related figures for the time display apparatus according to a preferred embodiment of the present invention, wherein the same elements are described by the same reference numerals.

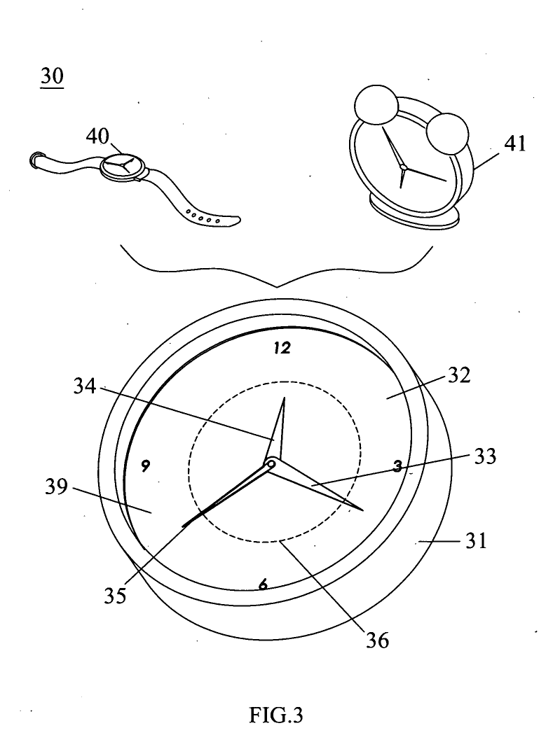

Referring to FIG. 3 for a schematic diagram illustrates a time display apparatus according to an embodiment of the present invention. The time display apparatus 30 includes a housing 31, a timetable panel 32, three pointers 33, 34, 35 and a backlight unit 36. The timetable panel 32 is disposed in the housing 31. The three pointers 33, 34, 35 made of a transparent material, such as a plastic material (not shown in the figure) or a glass, are coated with variety of phosphorescence materials respectively and vertically arranged on the timetable panel 32 in order. The backlight unit 36 is also disposed in the housing 31 and below the timetable panel 32. The backlight unit 36 can generate a light source with a fixed wavelength to illuminate the phosphorescence materials of the three pointers 33, 34, 35 to generate different colors for showing hour, minute and second respectively.

The housing 31 is a wrist watch 40 or a clock 41. The three pointers 33, 34, 35 are composed of an hour pointer 33, a minute pointer 34 and a second pointer 35. It should be noted that the hour pointer 33 is usually shorter than the minute pointer 34 and the second pointer 35 to conveniently recognize the difference. The second pointer 35 is therefore longer the minute pointer 34 and the second pointer 33. The housing 31 further comprises a transparent sheet 39 that is attached to a periphery of the housing 31 to protect the pointers 33, 34, 35 without being influenced by the environment such as wet, impurities or other smaller particles since the three pointers 33, 34, 35 are coated with variety of phosphorescence materials respectively. The phosphorescence materials have well stability and are illumination powder that are uniformly coated on the three pointers 33, 34, 35 made of a glass.

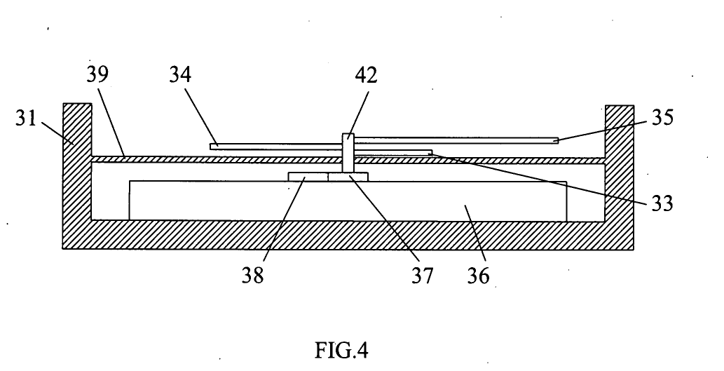

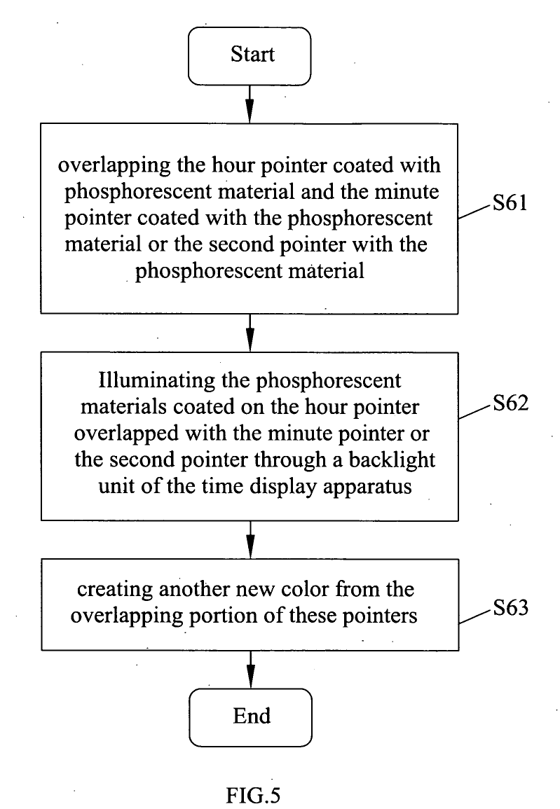

Referring to FIG. 4 for the cross-sectional diagram illustrates a time display apparatus according to an embodiment of the present invention. The time display apparatus 30 further comprises a timer 37 that is disposed under the timetable panel 32 to control the operation of the three pointers 33, 34, 35. The housing 31 further has a power supplier 38 that is attached under the timetable panel 32 to supply power to the backlight unit 36 and the timer 37. The three pointers 33, 34, 35 are fastened to a cylinder 39 disposed to a center of the timetable panel 32. Further, the cylinder 39 can pass through the timetable panel 32 and is controlled by the timer 37. When the power supplier 38 supplies the power to the timer 37 and the backlight unit 36, the timer 37 counts time and drives the cylinder 39 to control the pointers 33, 34, 35. The backlight unit 36 then generates the light with the fixed wavelength to illuminate the phosphorescence materials of the three pointers 33, 34, 35 to generate different colors for showing hour, minute and second respectively. Moreover, when the pointers 33, 34, 35 are overlapped, the overlapped portions can show another color through the illumination of the backlight unit 36.

FIG. 5 is a flowchart for creating various coloring by using different overlapping of pointers of the invention. Performing the colorful overlapping of the pointers in the preferred embodiment includes the following steps:
Step 51: overlapping the hour pointer coated with phosphorescent material and the minute pointer coated with the phosphorescent material or the second pointer with the phosphorescent material;
Step 52: illuminating the phosphorescent materials coated on the hour pointer overlapped with the minute pointer or the second pointer through a backlight unit of the time display apparatus; and
Step 53: creating another new color from the overlapping portion of these pointers.

Since these pointers are made of transparent materials, the light source generated by the backlight unit can illuminate the phosphorescent materials to generate different colors.

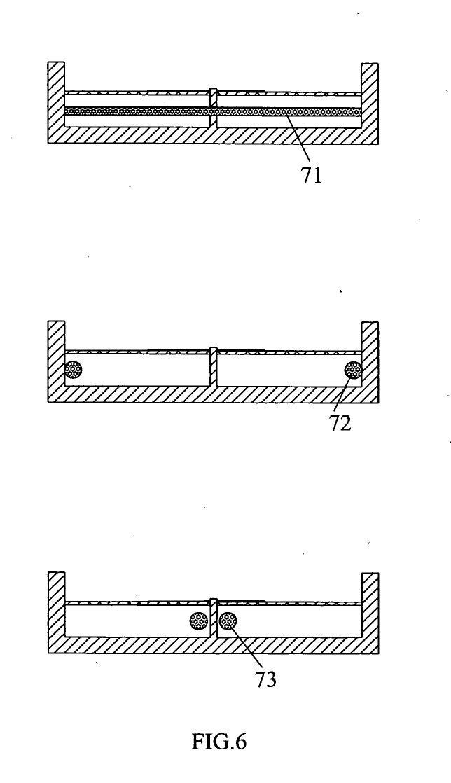

It is possible to have numerous variations by modifying the arrangement and appearance of the back light unit of the present invention. As illustrated in FIG. 6, it is a diagram of another embodiment of the present invention with back light units in various appearances and arrangements. There are at least three different applications by altering the appearance and arrangement of the backlight unit 36 wherein the first application on the top portion of FIG. 6 includes a backlight unit 36 which is a disk-like backlight unit distributed uniformly beneath the timetable panel 32 that forms a backlight unit 71 with flat piece; the second application in the middle position employs a backlight unit 36 which is a ring-shaped back light unit traveling circularly around the boarder of the housing 31 that forms a backlight unit 72 with circular shape; and third application in the bottom position utilizes a backlight unit 36 which is also a ring-shaped backlight unit but traveling circularly near the central point that forms a backlight unit 73 with central circular shape.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A time display apparatus, comprising:
a housing;
a timetable panel disposed in the housing;
three pointers coated with variety of phosphorescence materials respectively and vertically arranged on the timetable panel in order; and
a backlight unit disposed below the timetable panel, and for generating a light source with a fixed wavelength to illuminate the phosphorescence materials of the three pointers to generate different colors for showing hour, minute and second respectively.

2. The time display apparatus of claim 1, wherein the housing is a wrist watch or a clock.

3. The time display apparatus of claim 1 further comprising a timer that is disposed under the timetable panel to control the operation of the three pointers.

4. The time display apparatus of claim 1, wherein the three pointers further includes an hour pointer, a minute pointer and a second pointer.

5. The time display apparatus of claim 4, wherein the hour pointer is shorter than the minute pointer and the second pointer.

6. The time display apparatus of claim 4, wherein the second pointer is longer than the minute pointer and the hour pointer.

7. The time display apparatus of claim 1, wherein the three pointers are further fastened to a cylinder disposed to a center of the timetable panel.

8. The time display apparatus of claim 7, wherein the cylinder passes through the timetable panel and is controlled by the timer.

9. The time display apparatus of claim 1, wherein the housing further has a power supplier for supplying power to the backlight unit and the timer.

10. The time display apparatus of claim 1, wherein the housing further comprises a transparent sheet that is attached to a periphery of the housing.

11. The time display apparatus of claim 1, wherein the pointers are made of transparent materials, including a plastic material or a glass.
